(19) United States
(12) Patent Application Publication
(10) Pub. No.: US 2024/0356375 A1
(43) Pub. Date: Oct. 24, 2024

(54) COMBINATION BACKSCATTER DEVICE

(71) Applicant: Cisco Technology, Inc., San Jose, CA (US)

(72) Inventors: Jerome HENRY, Pittsboro, NC (US); Vinay SAINI, Bengaluru (IN); Robert E. BARTON, Richmond (CA)

(21) Appl. No.: 18/302,425

(22) Filed: Apr. 18, 2023

(51) Int. Cl. H02J 50/20; H02J 7/34

(52) U.S. Cl. CPC H02J 50/20; H02J 7/342; H02J 7/345

(57) ABSTRACT

The present disclosure describes a combination backscatter device and methods of operation involving the combination backscatter device. An apparatus includes a passive backscatter device, an active backscatter device, and a cover. The passive backscatter device transmits a first message using energy from a wireless signal. The active backscatter device includes a first capacitor that charges using energy from a wireless signal. The cover moves over the passive backscatter device based on an amount of energy stored in the first capacitor.

### TECHNICAL FIELD

Embodiments presented in this disclosure generally relate to wireless communication. More specifically, embodiments disclosed herein relate to ambient power devices.

### BACKGROUND

Ambient power (AMP) devices use energy from wireless signals over the air to drive or power transmissions. A passive backscatter device is an AMP device that uses a coil to reflect and modulate back the energy received over the air. An active backscatter device is an AMP device that harvests and stores energy from wireless signals over the air and that uses the energy to power transmissions.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example device in the system of FIG. 1.

FIG. 3 illustrates an example passive backscatter device in the device of FIG. 2.

FIGS. 4A and 4B illustrate example active backscatter devices in the device of FIG. 2.

FIGS. 5A and 5B illustrates an example device in the system of FIG. 1.

FIG. 6 is a flowchart of an example method performed in the system of FIG. 1.

FIG. 7 illustrates an example access point in the system of FIG. 1.

FIG. 8 is a flowchart of an example method performed in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a combination backscatter device and methods of operation involving the combination backscatter device. According to an embodiment, an apparatus includes a passive backscatter device, an active backscatter device, and a cover. The passive backscatter device transmits a first message using energy from a wireless signal. The active backscatter device includes a first capacitor that charges using energy from a wireless signal. The cover moves over the passive backscatter device based on an amount of energy stored in the first capacitor.

According to another embodiment, a system includes a first access point, a passive backscatter device, an active backscatter device, and a cover. The passive backscatter device transmits a first message using energy from a wireless signal from the first access point. The active backscatter device includes a first capacitor that charges using energy from a wireless signal from the first access point. The cover moves over the passive backscatter device based on an amount of energy stored in the first capacitor. The first access point determines a charge state of the first capacitor based on the first message.

According to another embodiment, a method includes transmitting, by a passive backscatter device, a first message using energy from a wireless signal and charging, a first capacitor of an active backscatter device, using energy from a wireless signal. The method also includes moving a cover over the passive backscatter device based on an amount of energy stored in the first capacitor.

### EXAMPLE EMBODIMENTS

An active backscatter device harvests and stores energy from wireless signals. For example, an access point in the network may transmit wireless charging frames to the active backscatter device. The active backscatter device may harvest and store energy from the charging frames. The active backscatter device then uses this energy to transmit messages.

It may be difficult, however, for the access point to know how much power the active backscatter device has stored. Thus, the access point may not know when to send charging frames or how long the charging frames should be to provide adequate energy to the active backscatter device. As a result, the active backscatter device may lose energy, and sometimes, stop transmitting altogether.

The present disclosure describes a combination backscatter device that includes a passive backscatter device, an active backscatter device, and a cover. The passive backscatter device transmits signals by reflecting and modulating wireless signals. The active backscatter device harvests and stores energy from wireless signals over the air. The active backscatter device may store this energy in a capacitor. The cover may move over the passive backscatter device to cover portions of the passive backscatter device. For example, as the capacitor stores more energy, the cover may move to reveal more of the passive backscatter device. As the capacitor loses energy, the cover may move to cover more of the passive backscatter device. The cover may distort the signal transmitted by the passive backscatter device. Thus, the distortion in the signal varies depending on how much energy is stored by the active backscatter device. By analyzing the signal from the passive backscatter device, it is possible to determine how much energy is stored by the active backscatter device. In this manner, an access point in the system may know when to send charging frames and how long the charging frames should be, in certain embodiments.

In certain embodiments, the combination backscatter device provides several technical advantages. For example, the combination backscatter device may use the cover and the passive backscatter device to signal how much energy is stored by the active backscatter device. As a result, the combination backscatter device may ensure that the combination backscatter device has sufficient energy to transmit relevant messages.

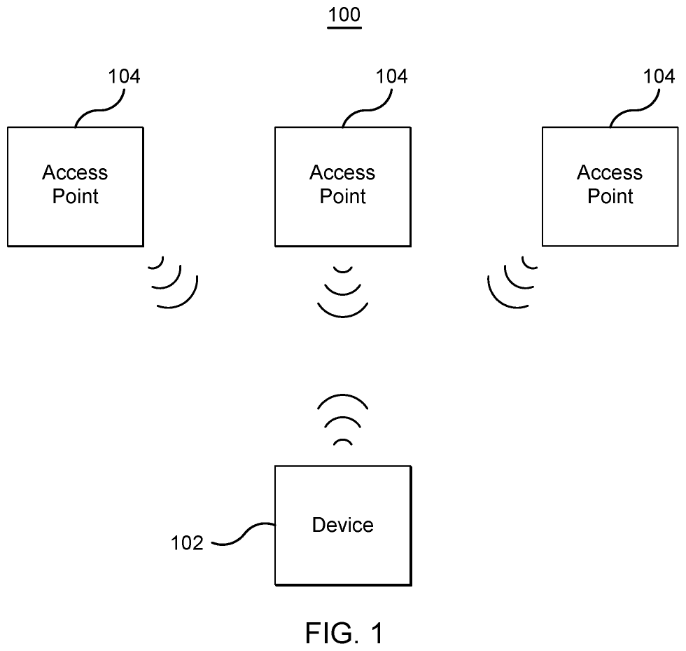

FIG. 1 illustrates an example system 100. As seen in FIG. 1, the system 100 includes a device 102 and one or more access points 104. Generally, the access points 104 communicate wireless signals towards the device 102. The device 102 may use the energy in the wireless signals to generate and transmit its own wireless signals. In this manner, the device 102 uses energy from over-the-air signals to operate.

The device 102 may be a combination backscatter device that includes a passive backscatter device and an active backscatter device. The device 102 may receive wireless signals over-the-air from one or more of the access points 104. The passive backscatter device may reflect or modulate these wireless signals (e.g., back to the access points 104). The active backscatter device may harvest and store energy from these wireless signals. When the active backscatter device has accumulated enough energy, the active backscatter device may use that energy to generate and transmit wireless signals.

In certain embodiments, the device 102 includes a cover that moves over the passive backscatter device. The cover may cover different portions of the passive backscatter device to distort a signal produced by the passive backscatter device. The size of the portion of the passive backscatter device that is covered by the cover may depend on the amount of energy stored by the active backscatter device. For example, the more energy that the active backscatter device has stored, the smaller the portion of the passive backscatter device that is covered by the cover. In this manner, different distortions are introduced into the signal produced by the passive backscatter device depending on the amount of energy stored by the active backscatter device.

The access point 104 may be any suitable wireless device that transmits wireless signals to the device 102. In the example of FIG. 1, the access point 104 may be a wireless fidelity (WiFi) access point 104 that provides network access for other devices in the system 100. The access point 104 may include radios that transmit wireless signals towards the device 102. For example, the access point may use the radios to transmit messages (e.g., charging frames) to the device 102. The device 102 may use the energy in these messages to charge the active backscatter device of the device 102. The access point 104 may also include radios that receive wireless signals from the device 102. For example, the access point 104 may receive messages produced by the passive backscatter device or the active backscatter device of the device 102.

As discussed previously, the messages produced by the passive backscatter device may include distortion that indicates an amount of energy stored by the active backscatter device. The access point 104 may detect the distortion in the message and determine an amount of energy stored by the active backscatter device. The access point 104 may then determine whether additional charging frames should be transmitted to the device 102 and how long these charging frames should be. The access point 104 may then transmit these charging frames to the device 102 to charge the active backscatter device. In this manner, the device 102 may signal an amount of energy stored by the active backscatter device, and the access points 104 may respond by providing charging frames to the active backscatter device in certain embodiments. As a result, the access point 104 and the device 102 may ensure that the active backscatter device receives a suitable amount of energy to operate.

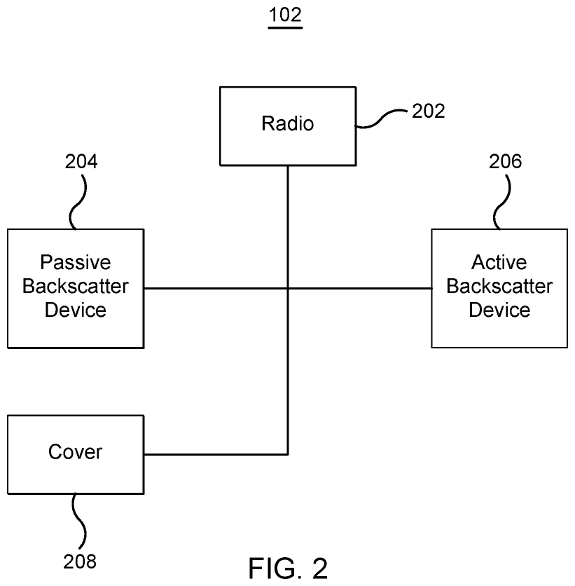

FIG. 2 illustrates an example device 102 in the system 100 of FIG. 1. As seen in FIG. 2, the device 102 includes a radio 202, a passive backscatter device 204, an active backscatter device 206, and a cover 208. Generally, the device 102 uses energy from over-the-air wireless signals to operate the passive backscatter device 204 and the active backscatter device 206. The cover 208 may move to cover different portions of the passive backscatter device 204 to distort a signal produced by the passive backscatter device 204. The amount of the passive backscatter device 204 covered by the cover 208 may depend on an amount of energy stored by the active backscatter device 206. As a result, the distortion present in the signal produced by the passive backscatter device 204 may indicate the amount of energy stored by the active backscatter device 206, in certain embodiments.

The radio 202 may receive wireless signals over-the-air. The radio 202 may include any suitable components to receive wireless signals. For example, the radio 202 may include an antenna that receives wireless signals from one or more of the access points 104. In some embodiments, these wireless signals may be charging frames sent by the access point 104 to provide energy to the passive backscatter device 204 or the active backscatter device 206. The radio 202 may also transmit wireless signals.

The passive backscatter device 204 may produce wireless signals by reflecting or modulating received over-the-air wireless signals. For example, wireless signals from the access point 104 may reach the passive backscatter device 204. The passive backscatter device 204 may include a coil that modulates the wireless signals and reflects or transmits the modulated wireless signals back towards the access point 104. In this manner, the passive backscratcher device 204 produces wireless signals through a passive mechanism. The passive backscatter device 204 may transmit these wireless signals asynchronously (e.g., not following or according to a clock signal).

The active backscatter device 206 harvests and stores energy from wireless signals. For example, the active backscatter device 206 may include rectifiers and diodes that harvest energy from the wireless signals received on the radio 202. Additionally, the active backscatter device 206 may include one or more capacitors that store the energy harvested from the wireless signals. The active backscatter device 206 may subsequently use the stored energy to generate and transmit wireless signals. For example, the active backscatter device 206 may use the stored energy to operate a clock and to generate and transmit wireless signals according to the clock. As a result, the active backscatter device 206 may generate and transmit synchronous wireless signals, while the passive backscatter device 204 may produce asynchronous wireless signals.

The cover 208 may move to cover different portions of the passive backscatter device 204 depending on an amount of energy stored by the active backscatter device 206. The device 102 may include motors or actuators that move the cover 208 depending on how much energy is stored by the active backscatter device 206. For example, the cover 208 may move to cover a large portion of the passive backscatter device 204 when the active backscatter device 206 has stored little or no energy. The cover 208 may move to cover a smaller portion of the passive backscatter device 204 when the active backscatter device 206 has stored a large amount of energy. By covering different portions or amounts of the passive backscatter device 204, the cover 208 may introduce different distortions into the signal produced by the passive backscatter device 204. As a result, the distortion in the signal produced by the passive backscatter device 204 may indicate an amount of energy stored by the active backscatter device 206. When an access point 104 in the system 100 receives the signal produced by the passive backscatter device 204, the access point 104 may determine the amount of energy stored by the active backscatter device 206 by examining or analyzing the distortion in the signal produced by the passive backscatter device 204.

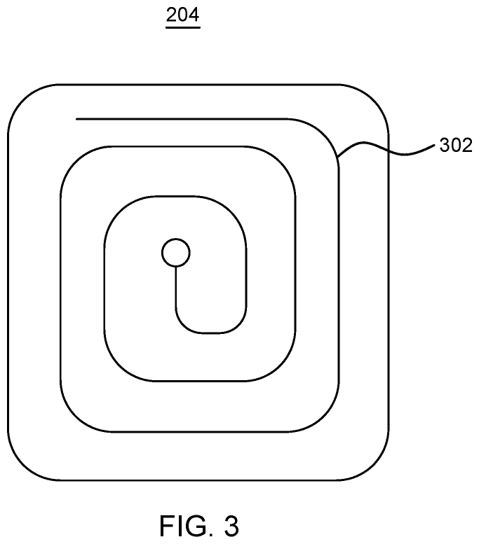

FIG. 3 illustrates an example passive backscatter device 204 in the device 102 of FIG. 2. As seen in FIG. 3, the passive backscatter device 204 includes a coil 302. The coil 302 may be electrically coupled to the radio 202 of the device 102. The coil 302 may receive wireless signals transmitted by the access points 104. Due to the shape and structure of the coil 302, the coil 302 may modulate the wireless signal and reflect or transmit the modulated wireless signal back towards the access point 104. In certain embodiments, the cover 108 may cover a portion of the coil 302 to distort the signal produced by the passive backscatter device 204 based on an amount of energy stored by the active backscatter device 206. As a result, the distortion in the signal produced by the passive backscatter device 204 indicates an amount of energy stored by the active backscatter device 206.

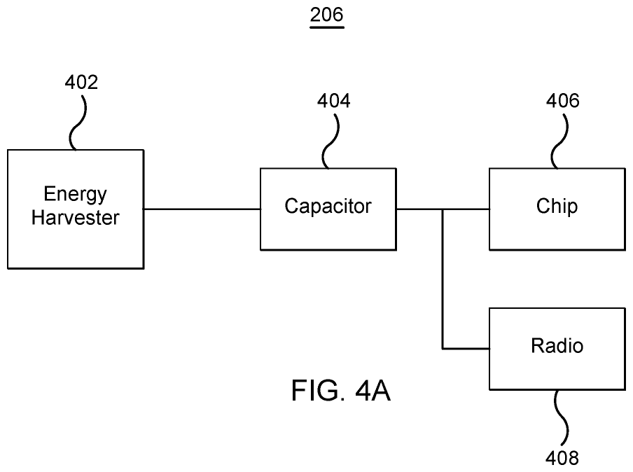

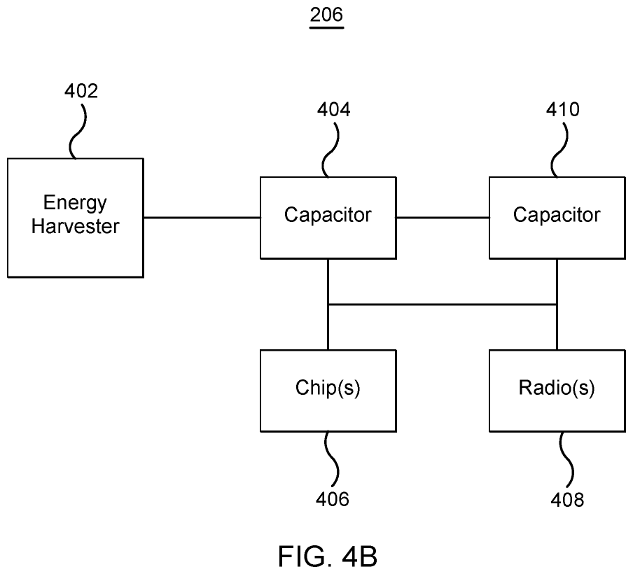

FIGS. 4A and 4B illustrate example backscatter devices 206 in the device 102 of FIG. 1. Generally, FIG. 4A illustrates a single stage active backscatter device 206, and Figure B illustrates a dual stage active backscatter device 206.

As see in FIG. 4A, the active backscatter device 206 includes an energy harvester 402, a capacitor 404, a chip 406, and a radio 408. Generally, these components may operate together to harvest and store energy from over-the-air wireless signals and to use that energy to generate and transmit wireless signals.

The energy harvester 402 may be a circuit connected to the radio 202 in the device 102. The energy harvester 402 may include rectifiers, diodes, and other circuit components that harvest or extract energy from wireless signals received by the radio 202 of the device 102. The energy harvester 402 may send the harvested energy to the capacitor 404 for storage. As the radio 202 of the device 102 receives more wireless signals from the access points 104, the energy harvester 402 may harvest and store more energy in the capacitor 404. The active backscatter device 206 may use the energy stored in the capacitor 404 to generate and transmit wireless signals.

When the capacitor 404 has stored a sufficient amount of energy, the active backscatter device 206 may use the energy in the capacitor 404 to power the chip 406 and the radio 408. For example, the energy in the capacitor 404 may be used to operate a clock and to power the chip 406 so that the chip 406 generates signals according to the clock. The chip 406 may be an integrated circuit that includes or encodes data or information in the signals. For example, the signals may include beacons or alerts. The energy in the capacitor 404 may also power the radio 408 to transmit the signals produced by the chip 406. The radio 408 may transmit the signals wirelessly to other components in the system 100. For example, the radio 408 may transmit the signals to access points 104 in the system 100 or to other readers in the system 100.

As seen in FIG. 4B, the active backscatter device 206 includes an additional capacitor 410. The energy harvester 402 is a circuit that includes rectifiers, diodes, or other components that harvest energy from wireless signals received by the radio 202 of the device 102. The energy harvester 402 may store the harvested energy in the capacitor 404. The energy in the capacitor 404 may be used to power one or more chips 406 and one or more radios 408 to generate and transmit wireless signals.

In some embodiments, when the capacitor 404 has stored sufficient energy, the active backscatter device 206 may operate in a first mode, and when the capacitor 410 has stored sufficient energy, the active backscatter device 206 may operate in a second mode. Specifically, when the capacitor 404 has stored a threshold level of energy or charged to a threshold capacity, the capacitor 404 may discharge into the capacitor 410 to charge the capacitor 410. The capacitor 404 may continue to be charged by the energy harvested by the energy harvester 402. As the capacitor 404 discharges into the capacitor 410, the capacitor 410 may charge. When the capacitor 410 stores a sufficient amount of energy, the capacitor 410 may power one or more of the chips 406 and one or more of the radios 408 to generate and transmit wireless signals. The signals generated by the chips 406 when powered by the capacitor 410 may be different from the signals generated by the chips 406 when powered by the capacitor 404. For example, when the chips 406 are powered by the capacitor 404, the chips 406 may generate signals using less energy than when the chips 406 are powered by the capacitor 410. The chips 406 may generate signals less frequently, or according to a slower clock. When the chips 406 are powered by the capacitor 410, the chips 406 may generate longer signals or more frequent signals. The chips 406 may also operate according to a faster clock. In this manner, the active backscatter device 206 generates and transmits different signals depending on whether the capacitor 410 and/or the capacitor 404 have stored sufficient energy.

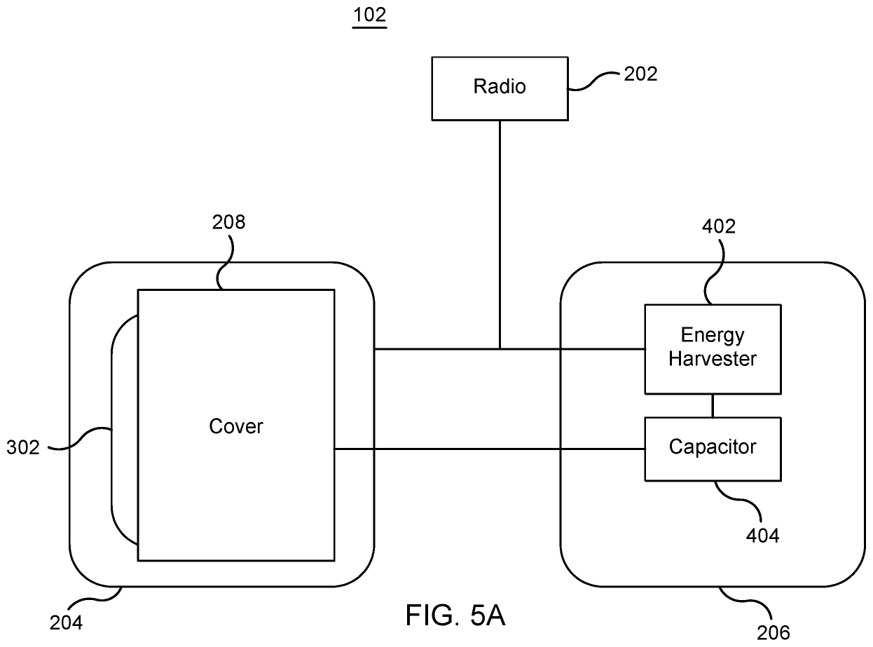

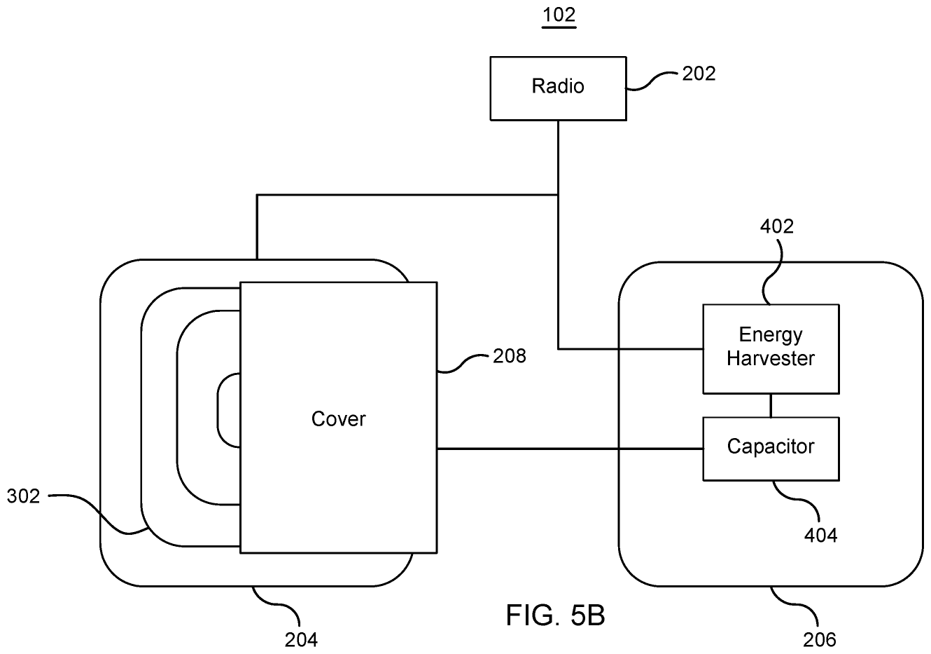

FIGS. 5A and 5B illustrate an example device 102 in the system 100 of FIG. 1. Generally, FIGS. 5A and 5B show two different states of the device 102. In the state shown in FIG. 5A, the device 102 has stored less energy than the device 102 shown in the state of FIG. 5B.

As see in FIG. 5A, the cover 208 has covered almost all of the coil 302 of the passive backscatter device 204. The cover 208 may cover such a large portion of the coil 302, because the capacitor 404 in the active backscatter device 206 may not have stored a large amount of energy. The cover 208 thus introduces a large amount of distortion into the signal produced by the passive backscatter device 204. When the passive backscatter device 204 transmits the distorted signal, the passive backscatter device 204 may signal, by the distortion, that the capacitor 404 has not stored a large amount of energy.

As the radio 202 receives wireless signals (e.g., charging frames) from the access points 104, the energy harvester 402 may harvest the energy from the wireless signals and store that energy in the capacitor 404. Thus, the amount of energy stored by the capacitor 404 increases. As the amount of energy in the capacitor 404 increases, the cover 208 may move to reveal more of the coil 302. As seen in FIG. 5B, the coil 208 has moved to cover less of the coil 302 of the passive backscatter device 204. As a result, more of the coil 302 is revealed. By moving the cover 208, the amount of distortion introduced by the cover 208 into the signals produced by the passive backscatter device 204 changes. When an access point 104 receives the signal produced by the passive backscatter device 204, the access point 104 may understand from the distortion in the signal, that the capacitor 404 is storing a larger amount of energy. In this manner, the device 102 signals to the access points 104 an amount of energy stored by the active backscatter device 206.

In some embodiments, the device 102 includes motors or actuators that move the cover 208 depending on the amount of energy stored in the capacitor 404. The motors or actuators may activate when the amount of energy stored in the capacitor 404 changes. Activation of the motor or actuators causes the cover 208 to move to cover more or less of the coil 302. As a result, the cover 208 introduces different amounts of distortion depending on the amount of energy stored in the capacitor 404.

In some embodiments, the active backscatter device 206 includes the capacitor 410. The cover 208 may move to cover different portions of the coil 302 depending on the amount of energy stored in the capacitor 404 and/or the capacitor 410. For example, when the capacitor 410 has a sufficient amount of energy, the cover 208 may move to reveal almost all of the coil 302, even if the capacitor 404 has little to no energy stored. In this manner, the cover 208 introduces distortion based on an amount of energy stored by the capacitor 404 and the capacitor 410.

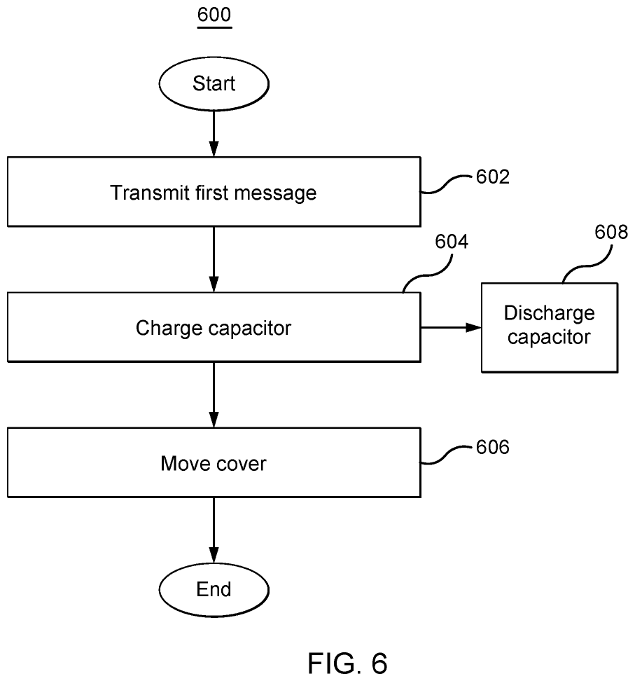

FIG. 6 is a flowchart of an example method 600 performed in the system 100 of FIG. 1. In particular embodiments, the device 102 performs the method 600. By performing the method 600, the device 102 uses the passive backscatter device 204 to signal an amount of energy stored by the active backscatter device 206.

In block 602, the passive backscatter device 204 of the device 102 transmits a first message. The passive backscatter device 204 may produce the first message by modulating and reflecting wireless signals received by the passive backscatter device 204. For example, the passive backscatter device 204 may include the coil 302 that modulates and reflects the signal.

In block 604, the active backscatter device 206 charges a capacitor 404. The active backscatter device 206 may include the energy harvester 402 that harvests energy from wireless signals received by the radio 202. The energy harvester 402 may include rectifiers, diodes, and other circuit components that harvest or extract energy from the wireless signals received by the radio 202. The energy harvester 402 may store that energy into the capacitor 404 to charge the capacitor 404.

As the amount of energy stored in the capacitor 404 changes, the device 102 may move the cover 208 in block 606. The device 102 may include motors or actuators that move the cover 208 when activated. The cover 208 may be moved so that the cover 208 covers different portions of the coil 302 of the passive backscatter device 204. The amount of the coil 302 covered by the cover 208 may depend on the amount of energy stored by the capacitor 404. For example, when the capacitor 404 has more energy stored, the cover 208 may be moved to cover less of the coil 302. When the capacitor 404 has less energy stored, the cover 208 may be moved to cover more of the coil 302. As the cover 208 moves, the amount of distortion introduced by the cover 208 into signals produced by the passive backscatter 204 changes. Thus, the amount of distortion present in the signal produced by the passive backscatter device 204 may indicate an amount of energy stored by the capacitor 404. When the capacitor 404 has stored a sufficient amount of energy, the capacitor 404 may begin powering chips 406 and radios 408 in the active backscatter device 206 to generate and transmit wireless signals.

In some embodiments, when the capacitor 404 has stored a threshold amount of energy, the capacitor 404 may discharge to the capacitor 410 in block 608. The capacitor 410 may then begin storing the energy from the capacitor 404. The capacitor 404 may continue to charge using the energy harvested by the energy harvester 402. When the capacitor 410 has stored a sufficient amount of energy, the capacitor 410 may begin powering chips 406 in radios 408 in the active backscatter device 206.

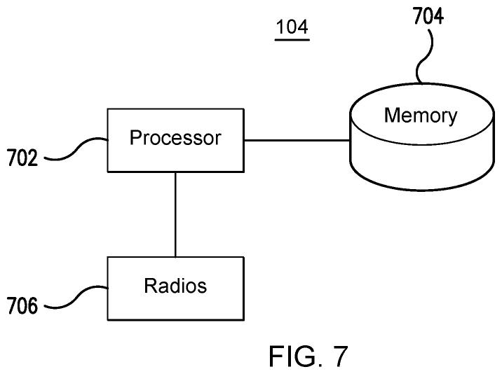

FIG. 7 illustrates an example access point 104 in the system 100 of FIG. 1. As seen in FIG. 7, the access point 104 includes a processor 702, a memory 704, and one or more radios 706. Generally, the access point 104 may transmit and receive wireless signals (e.g., to and from the device 102). The processor 702, the memory 704, and the radios 706 may perform any of the actions or functions of the access point 104 described herein.

The processor 702 is any electronic circuitry, including, but not limited to one or a combination of microprocessors, microcontrollers, application specific integrated circuits (ASIC), application specific instruction set processor (ASIP), and/or state machines, that communicatively couples to memory 704 and controls the operation of the access point 104. The processor 702 may be 8-bit, 16-bit, 32-bit, 64-bit or of any other suitable architecture. The processor 702 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 702 may include other hardware that operates software to control and process information. The processor 702 executes software stored on the memory 704 to perform any of the functions described herein. The processor 702 controls the operation and administration of the access point 104 by processing information (e.g., information received from the device 102, memory 704, and radios 706). The processor 702 is not limited to a single processing device and may encompass multiple processing devices.

The memory 704 may store, either permanently or temporarily, data, operational software, or other information for the processor 702. The memory 704 may include any one or a combination of volatile or non-volatile local or remote devices suitable for storing information. For example, the memory 704 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 704, a disk, a CD, or a flash drive. In particular embodiments, the software may include an application executable by the processor 702 to perform one or more of the functions described herein.

The access point 104 may include any suitable number of radios 706. The access point 104 may use the radios 706 to transmit and receive wireless signals to and from the device 102. For example, the access point 104 may use the radio 706 to transmit charging frames to the device 102. The charging frames may be wireless signals that are intended to provide energy that the device 102 may harvest. The device 102 may then use the harvested energy to generate and transmit wireless signals to the access point 104.

In some embodiments, the access point 104 may receive wireless signals from the passive backscatter device 204 of the device 102. The wireless signals may include distortions introduced by the cover 208 covering a portion of the passive backscatter device 204. The access point 104 may analyze the distortion present in the wireless signal to determine an amount of energy stored by the active backscatter device 206 of the device 102. The access point 104 may then adjust the charging frames sent by the access point 104 to the device 102. For example, if the access point 104 determines that the device 102 needs additional energy, the access point 104 may transmit charging frames more frequently or transmit longer charging frames to the device 102. As another example, the access point 104 may adjust beamforming configurations to direct additional energy towards the device 102. In this manner, the access point 104 may determine an amount of energy stored by the active backscatter device 206 and transmit charging frames accordingly.

In some embodiments, the access point 104 may coordinate transmissions with other access points 104 in the system 100 to provide energy to the device 102. For example, when the access point 104 determines from the wireless signals received from the passive backscatter device 204 that the active backscatter device 206 needs additional energy, the access point 104 may communicate with other access points 104 to send the charging frames to the device 102. For example, the access point 104 may communicate messages to the other access points 104 and instruct the other access points 104 to transmit charging frames to the device 102. In response, the other access points 104 may transmit charging frames to the device 102. As a result, the device 102 may receive additional energy from the other access points 104, and the active backscatter device 206 may charge more quickly.

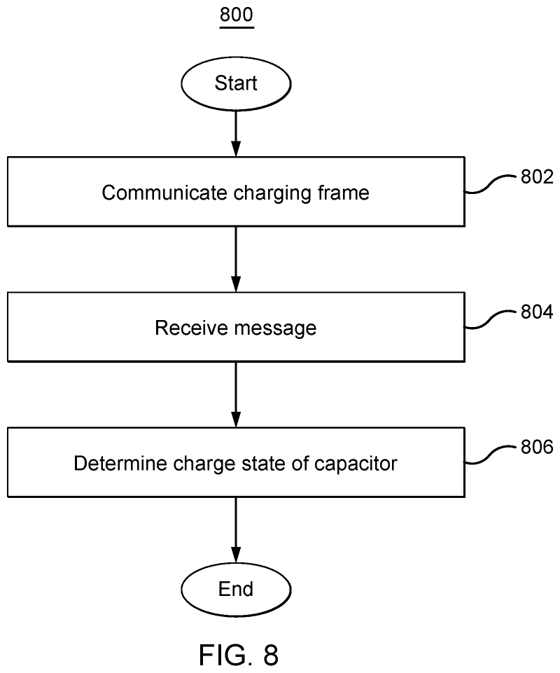

FIG. 8 is a flowchart of an example method 800 performed in the system 100 of FIG. 1. In particular embodiments, the access point 104 performs the method 800. By performing the method 800, the access point 104 determines a charge state of the active backscatter device 206 of the device 102.

In block 802, the access point 104 communicates a charging frame to the device 102. The charging frame may be a wireless signal intended to deliver energy to the device 102. The device 102 may include an energy harvester 402 that harvests energy from the charging frame.

In block 804, the access point 104 receives a message from the device 102. The message may have been produced or generated by the passive backscatter device 204 of the device 102. The message may include an amount of distortion caused by the cover 208 covering a portion of the passive backscatter device 204. The cover 208 may move to cover different portions of the passive backscatter device 204 depending on an amount of energy stored by the active backscatter device 206. The access point 104 may analyze the distortion in the message to determine the amount of energy stored by the active backscatter device 206.

In block 806, the access point 104 determines a charge state of the capacitor 404 of the active backscatter device 206. The access point 104 may analyze the distortion in the message to determine the charge state. The charge state may indicate an amount of energy stored by the capacitor 404 of the active backscatter device 206. In some embodiments, the access point 104 may determine that additional charging frames should be transmitted to the device 102 to deliver additional energy to the device 102. In response, the access point 104 may communicate additional charging frames to the device 102. In some embodiments, the access point 104 may coordinate or instruct other access points 104 to communicate additional charging frames to the device 102.

In summary, a combination backscatter device 102 includes a passive backscatter device 204, an active backscatter device 206, and a cover 208. The passive backscatter device 204 transmits signals by reflecting and modulating wireless signals. The active backscatter device 206 harvests and stores energy from wireless signals over the air. The active backscatter device 206 may store this energy in a capacitor 404. The cover 208 may move over the passive backscatter device 204 to cover portions of the passive backscatter device 204. For example, as the capacitor 404 stores more energy, the cover 208 may move to reveal more of the passive backscatter device 206. As the capacitor 404 loses energy, the cover 208 may move to cover more of the passive backscatter device 204. The cover 208 may distort the signal transmitted by the passive backscatter device 204. Thus, by analyzing the signal from the passive backscatter device 204, it is possible to determine how much energy is stored by the active backscatter device 206. In this manner, an access point 104 in the system 100 may know when to send charging frames and how long the charging frames should be, in certain embodiments.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
a passive backscatter device arranged to transmit a first message using energy from a wireless signal;
an active backscatter device comprising a first capacitor arranged to charge using energy from a wireless signal; and
a cover arranged to move over the passive backscatter device based on an amount of energy stored in the first capacitor.

2. The apparatus of claim 1, wherein as the first capacitor charges, the cover moves to cover a smaller portion of the passive backscatter device.

3. The apparatus of claim 1, wherein the cover distorts the first message differently based on a size of a portion of the passive backscatter device covered by the cover.

4. The apparatus of claim 1, wherein the active backscatter device further comprises a second capacitor arranged to store energy from the first capacitor, and wherein the first capacitor discharges into the second capacitor when the first capacitor charges to a threshold capacity.

5. The apparatus of claim 4, wherein the active backscatter device is arranged to transmit a second message using energy from the first capacitor.

6. The apparatus of claim 5, wherein the active backscatter device is arranged to transmit a third message using energy from the second capacitor.

7. The apparatus of claim 1, further comprising a radio connected to the passive backscatter device and the active backscatter device.

8. An access point comprising:
a memory; and
a processor communicatively coupled to the memory, the processor configured to:
receive signals from a passive backscatter device, wherein a distortion in the signals varies based on a cover that moves over the passive backscatter device, wherein the cover moves over the passive backscatter device based on an amount of energy stored by an active backscatter device; and
determine the amount of energy stored by the active backscatter device based on the distortion in the signals.

9. The access point of claim 8, wherein the processor is further configured to communicate a charging frame to the active backscatter device based on the amount of energy stored by the active backscatter device.

10. The access point of claim 9, wherein the processor is further configured to vary a length of the charging frame based on the amount of energy stored by the active backscatter device.

11. The access point of claim 9, wherein the processor is further configured to vary a frequency of the charging frame based on the amount of energy stored by the active backscatter device.

12. The access point of claim 8, wherein the processor is further configured to request, based on the amount of energy stored by the active backscatter device, another access point to communicate a charging frame to the active backscatter device.

13. The access point of claim 8, wherein the processor is further configured to adjust a beamforming configuration towards the active backscatter device based on the amount of energy stored by the active backscatter device.

14. A method comprising:
transmitting, by a passive backscatter device, a first message using energy from a wireless signal;
charging, a first capacitor of an active backscatter device, using energy from a wireless signal; and
moving a cover over the passive backscatter device based on an amount of energy stored in the first capacitor.

15. The method of claim 14, wherein as the first capacitor charges, the cover moves to cover a smaller portion of the passive backscatter device.

16. The method of claim 14, wherein the cover distorts the first message differently based on a size of a portion of the passive backscatter device covered by the cover.

17. The method of claim 14, further comprising:
storing, by a second capacitor of the active backscatter device, energy from the first capacitor; and
discharging, by the first capacitor, into the second capacitor when the first capacitor charges to a threshold capacity.

18. The method of claim 17, further comprising transmitting a second message using energy from the first capacitor.

19. The method of claim 18, further comprising transmitting a third message using energy from the second capacitor.

20. The method of claim 14, wherein a radio is connected to the passive backscatter device and the active backscatter device.
